(19) United States
(12) Patent Application Publication
(10) Pub. No.: US 2009/0310711 A1
(43) Pub. Date: Dec. 17, 2009

(54) Transmitter and receiver capable of reducing in-phase/quadrature-phase (I/Q) mismatch and an adjusting method thereof

(76) Inventors: Yung-Ming Chiu, Taipei County (TW); Wen-Shan Wang, Tainan County (TW); Hong-Ta Hsu, Hsinchu City (TW); Ming-Chung Huang, Taichung City (TW)

Correspondence Address: JACOBSON HOLMAN PLLC, 400 SEVENTH STREET N.W., SUITE 600, WASHINGTON, DC, 20004, US

(21) Appl. No.: 12/457,528

(22) Filed: Jun. 15, 2009

(30) Foreign Application Priority Data
Jun. 16, 2008 (TW) 097122395

(51) Int. Cl. H04L 27/00; H04L 27/20; H04L 27/22

(52) U.S. Cl. 375/302; 375/322

(57) ABSTRACT

An adjusting method for reducing in-phase/quadrature-phase (I/Q) mismatch in a transmitter includes the steps of: a) receiving a first in-phase signal and a first quadrature-phase signal; b) adjusting a set of parameters such that an extent of I/Q mismatch related to the first in-phase signal and the first quadrature-phase signal is reduced; c) receiving a second in-phase signal and a second quadrature-phase signal, the second in-phase signal differing from the first in-phase signal in one of frequency and phase; d) adjusting the set of parameters such that an extent of I/Q mismatch related to the second in-phase signal and the second quadrature-phase signal is reduced; and e) determining final values for the set of parameters based on adjustment results of steps b) and d) such that extents of I/Q mismatch related to different frequencies are reduced.

### CROSS-REFERENCE TO RELATED APPLICATION

This application claims priority of Taiwanese Application No. 097122395, filed on Jun. 16, 2008.

### BACKGROUND OF THE INVENTION

1. Field of the Invention

The invention relates to a transmitter, a receiver and an adjusting method thereof, more particularly to a transmitter and a receiver capable of reducing in-phase/quadrature-phase (I/Q) mismatch, and an adjusting method thereof.

2. Description of the Related Art

As shown in FIG. 1, a conventional direct up-conversion transmitter includes first and second digital-to-analog converters 11, 12, first and second low-pass filters 13, 14, first and second mixers 15, 16, an adder 17, a power amplifier 18, and an antenna 19. On an in-phase path, a digital base band signal (BBIₜ) undergoes in sequence digital-to-analog conversion by the first digital-to-analog converter 11, low-pass filtering by the first low-pass filter 13, and mixing with an in-phase local oscillator signal (LOIₜ) by the first mixer 15 so as to generate an analog in-phase radio frequency signal (RFIₜ). On a quadrature-phase path, another digital base band signal (BBQₜ) undergoes in sequence digital-to-analog conversion by the second digital-to-analog converter 12, low-pass filtering by the second low-pass filter 14, and mixing with a quadrature-phase local oscillator signal (LOQₜ) by the second mixer 16 so as to generate an analog quadrature-phase radio frequency signal (RFQₜ). The analog in-phase radio frequency signal (RFIₜ) and the analog quadrature-phase radio frequency signal (RFQₜ) are combined by the adder 17, the result of which is amplified by the power amplifier 18 for subsequent transmission to the environment via the antenna 19.

As shown in FIG. 2, a conventional direct down-conversion receiver includes an antenna 21, a low noise amplifier (LNA) 22, first and second mixers 23, 24, first and second low-pass filters 25, 26, and first and second analog-to-digital converters 27, 28. After an analog radio frequency signal is received via the antenna 21 and amplified by the low noise amplifier 22, on an in-phase path, the amplified analog radio frequency signal undergoes in sequence mixing with an in-phase local oscillator signal (LOIᵣ) by the first mixer 23, low-pass filtering by the first low-pass filter 25, and analog-to-digital conversion by the first analog-to-digital converter 27 so as to generate a digital in-phase base band signal (BBIᵣ). On the other hand, on a quadrature-phase path, the amplified analog radio frequency signal undergoes in sequence mixing with an in-phase local oscillator signal (LOQᵣ) by the second mixer 24, low-pass filtering by the second low-pass filter 26, and analog-to-digital conversion by the second analog-to-digital converter 28 so as to generate a digital quadrature-phase base band signal (BBQᵣ).

An amplitude offset and a phase offset exist in practice between the in-phase component blocks (i.e., the component blocks on the in-phase path) and the quadrature-phase component blocks (i.e., the component blocks on the quadrature-phase path). This phenomenon is referred to as in-phase/quadrature-phase (I/Q) mismatch or in-phase/quadrature-phase (I/Q) imbalance. This phenomenon reduces signal-to-noise ratio (SNR) of signals transmitted by the conventional direct up-conversion transmitter and received by the down-conversion receiver, and eventually results in loss of data. At present, conventional technologies for reducing I/Q mismatch have been proposed, which treat the phase offset as a constant value throughout the frequency bandwidth of the signal, and adjustment to reduce the phase offset is only conducted for a specific frequency.

Referring to FIG. 2 and FIGS. 3(a) and 3(b), taking the down-conversion receiver as an example, if there is a group delay offset (shown by (τ₁) in FIG. 2) between input ends of the first and second mixers 23, 24, then the resultant phase offset would be a constant value in the signal bandwidth of between (−fₘ) to (fₘ) as shown in FIG. 3(a). Under this circumstance, the conventional technologies are sufficient for reducing the constant phase offset effectively. However, if there is a group delay offset (shown by (τ₂) in FIG. 2) between output ends of the first and second frequency mixers 23, 24, then the resultant phase offset is linearly proportional to the frequencies in the signal bandwidth of between (−fₘ) to (fₘ) as shown in FIG. 3(b). Under this situation, the conventional technologies are unable to reduce the phase offset whose value is related to the frequency.

### SUMMARY OF THE INVENTION

Therefore, the object of the present invention is to provide an adjusting method for reducing I/Q mismatch and capable of reducing phase offsets that are related to frequency.

Accordingly, there is provided an adjusting method for reducing in-phase/quadrature-phase (I/Q) mismatch in a transmitter. The adjusting method includes the steps of:

a) receiving a first in-phase signal and a first quadrature-phase signal;

b) adjusting a set of parameters such that an extent of I/Q mismatch related to the first in-phase signal and the first quadrature-phase signal is reduced;

c) receiving a second in-phase signal and a second quadrature-phase signal, the second in-phase signal differing from the first in-phase signal in one of frequency and phase;

d) adjusting the set of parameters such that an extent of I/Q mismatch related to the second in-phase signal and the second quadrature-phase signal is reduced; and

e) determining final values for the set of parameters based on adjustment results of steps b) and d) such that extents of I/Q mismatch related to different frequencies are reduced.

According to another aspect of the present invention, there is provided an adjusting method for reducing in-phase/quadrature-phase (I/Q) mismatch in a receiver. The adjusting method includes the steps of:

a) receiving a first radio-frequency signal that is generated from a first in-phase signal and a first quadrature-phase signal;

b) adjusting a set of parameters such that an extent of I/Q mismatch related to the first radio-frequency signal is reduced;

c) receiving a second radio-frequency signal that is generated from a second in-phase signal and a second quadrature-phase signal, the second in-phase signal differing from the first in-phase signal in one of frequency and phase;

d) adjusting the set of parameters such that an extent of I/Q mismatch related to the second radio-frequency signal is reduced; and

e) determining final values for the set of parameters based on adjustment results of steps b) and d) such that extents of I/Q mismatch related to different frequencies are reduced.

Another object of the present invention is to provide a transmitter and a receiver capable of reducing phase offsets that are related to frequency.

According to yet another aspect of the present invention, there is provided a transmitter that includes a transmitting module, a detecting unit, and an adjusting unit.

The transmitting module performs phase and amplitude compensation according to a set of parameters, as well as signal mixing on an in-phase signal and a quadrature-phase signal, followed by combining to result in a radio-frequency signal.

The detecting unit is coupled electrically to the transmitting module, and generates a detection signal that represents an extent of in-phase/quadrature-phase (I/Q) mismatch based on the radio-frequency signal received from the transmitting module.

The adjusting unit is coupled electrically to the transmitting module and the detecting unit, and controls values of the set of parameters according to the detection signal received from the detecting unit so as to reduce the extent of I/Q mismatch.

The adjusting unit adjusts the values of the set of parameters when the detection signal is generated for a first set of in-phase and quadrature-phase signals such that the extent of I/Q mismatch related to the first set of in-phase and quadrature-phase signals is reduced, adjusts the values of the set of parameters when the detection signal is generated for a second set of in-phase and quadrature-phase signals such that the extent of I/Q mismatch related to the second set of in-phase and quadrature-phase signals is reduced, and determines final values of the set of parameters based on the adjustment results such that the extents of I/Q mismatch related to different frequencies are reduced.

The second in-phase signal differs from the first in-phase signal in one of frequency and phase.

According to still another aspect of the present invention, there is provided a receiver that includes a receiving module, a detecting unit, and an adjusting unit.

The receiving module performs in-phase signal and quadrature-phase signal mixing, as well as phase and amplitude compensation according to a set of parameters, on a radio-frequency signal received thereby so as to generate a pair of baseband in-phase and quadrature-phase signals.

The detecting unit is coupled electrically to the receiving module, and generates a detection signal that represents an extent of in-phase/quadrature-phase (I/Q) mismatch based on the baseband in-phase and quadrature-phase signals received from the receiving module.

The adjusting unit is coupled electrically to the receiving module and the detecting unit, and controls values of the set of parameters according to the detection signal received from the detecting unit so as to reduce the extent of I/Q mismatch.

The adjusting unit adjusts the values of the set of parameters when the detection signal is generated for a first radio frequency signal such that the extent of I/Q mismatch related to the first radio frequency signal is reduced, adjusts the values of the set of parameters when the detection signal is generated for a second radio frequency signal such that the extent of I/Q mismatch related to the second radio frequency signal is reduced, and determines final values of the set of parameters based on the adjustment results such that the extents of I/Q mismatch related to different frequencies are reduced.

The receiving module generates a pair of first baseband in-phase and quadrature-phase signals from the first radio frequency signal, and generates a pair of second baseband in-phase and quadrature-phase signals from the second radio frequency signal. The second baseband in-phase signal differs from the first baseband in-phase signal in one of frequency and phase.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional direct up-conversion transmitter;

FIG. 2 is a schematic diagram of a conventional direct down-conversion receiver;

FIG. 3(a) is a plot, illustrating a phase offset that does not vary with frequency;

FIG. 3(b) is a plot, illustrating a phase offset that is linearly proportional to frequency;

FIG. 4 is a schematic diagram of a transmitter according to the preferred embodiment of the present invention;

FIG. 5 is a flowchart of an adjusting method for reducing I/Q mismatch according to the preferred embodiment and implemented using the transmitter shown in FIG. 4;

FIGS. 6(a) to 6(l) show a set of frequency spectra used to illustrate the effects achieved by the transmitter of the present invention;

FIGS. 7(a) to 7(l) show a set of frequency spectra used to illustrate the effects achieved by the transmitter of the present invention;

FIG. 8 is a schematic diagram of a receiver according to the preferred embodiment of the present invention; and

FIG. 9 is a flowchart of an adjusting method for reducing I/Q mismatch according to the preferred embodiment and implemented using the receiver shown in FIG. 8.

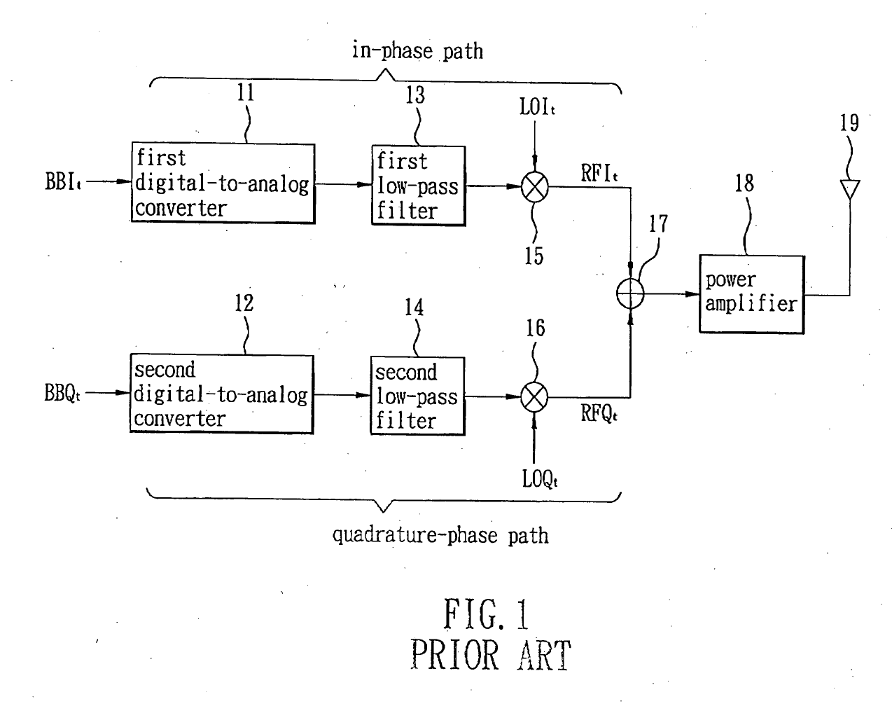

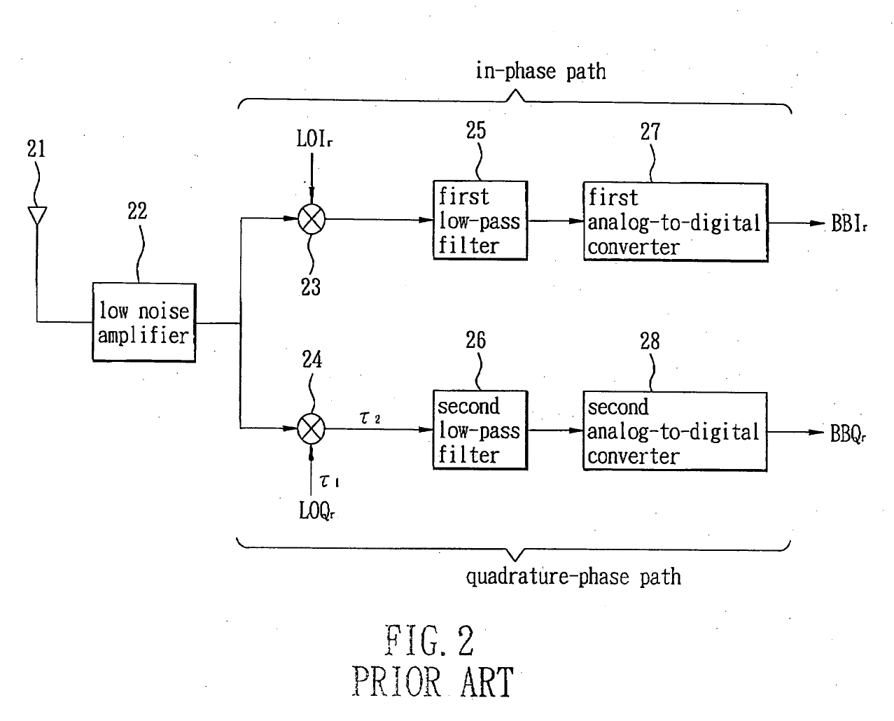

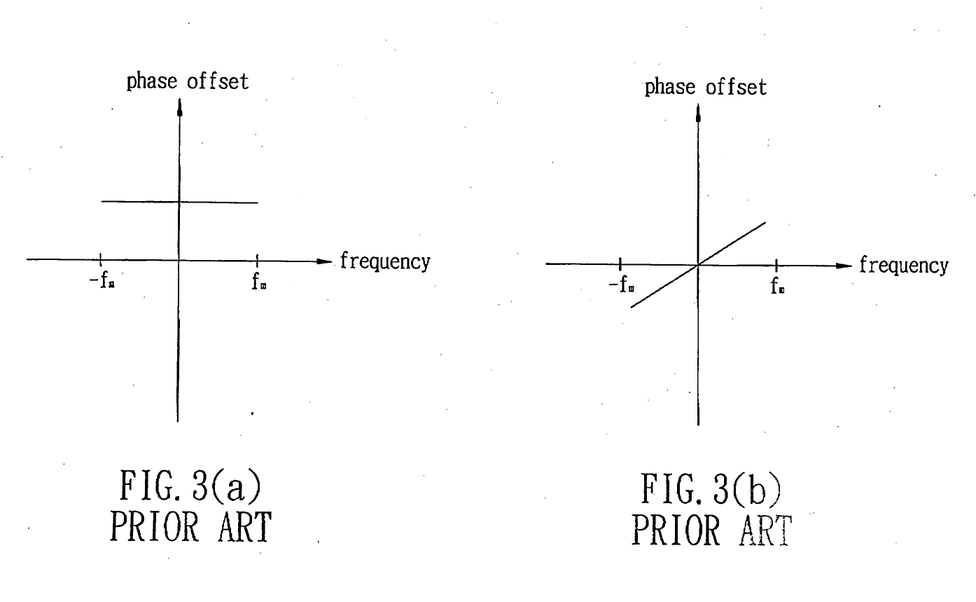

### DETAILED DESCRIPTION OF THE PREFERRED EMBODIMENT

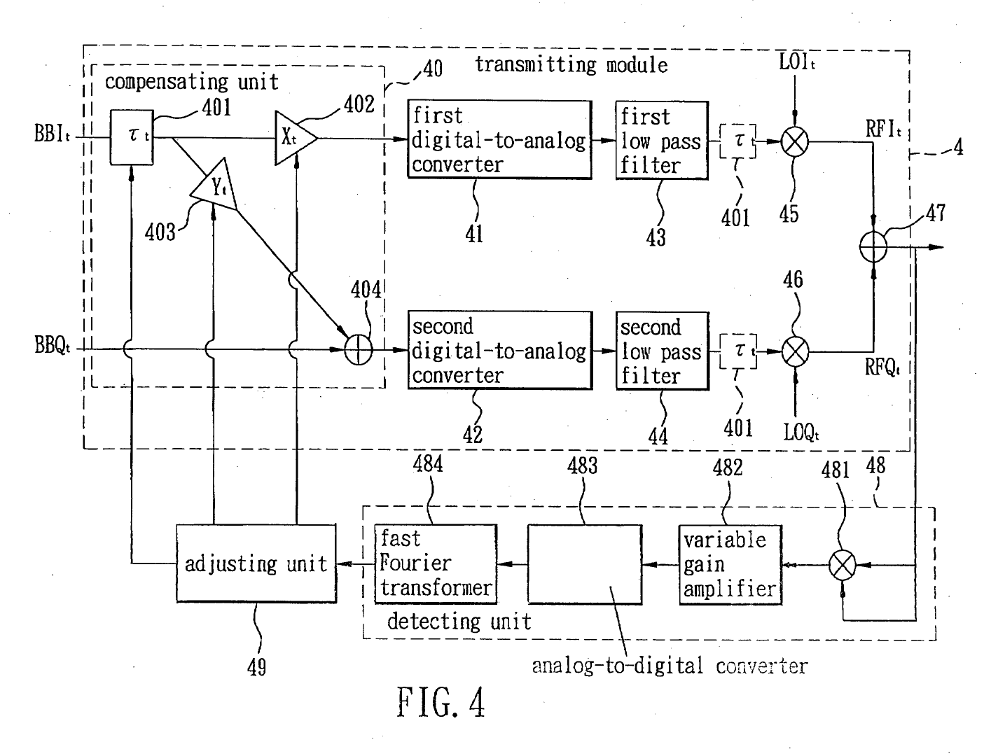

Referring to FIG. 4, the preferred embodiment of a transmitter according to the present invention is shown to include a transmitting module 4, a detecting unit 48, and an adjusting unit 49. The transmitting module 4 includes a compensating unit 40, first and second digital-to-analog converters 41, 42, first and second low pass filters 43, 44, first and second mixers 45, 46, and an adder 47, and performs phase and amplitude compensation according to a set of parameters, as well as signal mixing on an in-phase signal and a quadrature-phase signal, followed by combining to result in a radio-frequency signal.

In particular, the compensating unit 40 performs phase and amplitude compensation on first and second digital baseband signals (BBIₜ), (BBQₜ) according to a set of parameters. In this embodiment, the set of parameters includes a variable delay time (τₜ) and a pair of variable gains (Xₜ), (Yₜ). The variable delay time (τₜ) is for use in frequency-dependent phase compensation, and the variable gains (Xₜ), (Yₜ) are for use in fixed amplitude compensation and fixed phase compensation. The compensating unit 40 includes a delay stage 401, first and second gain stages 402, 403, and an adder 404. The delay stage 401 delays the baseband signal (BBIₜ) by the variable delay time (τₜ). The first gain stage 402 multiplies the signal outputted by the delay stage 401 by the variable gain (Xₜ) so as to generate a first output signal of the compensating unit 40. The second gain stage 403 multiplies the signal outputted by the delay stage 401 by the variable gain (Yₜ), which is subsequently combined by the adder 404 with the second baseband signal (BBQₜ) so as to generate a second output signal of the compensating unit 40.

The first and second digital-to-analog converters 41, 42 respectively perform digital-to-analog conversion on the first and second output signals of the compensating unit 40. The first and second low pass filters 43, 44 respectively perform low pass filtering on the signals outputted by the first and second digital-to-analog converters 41, 42. The first mixer 45 performs signal mixing on the signal outputted by the first low pass filter 43 with an in-phase local oscillating signal (LOIₜ) so as to generate an in-phase radio-frequency signal (RFIₜ), whereas the second mixer 46 performs signal mixing on the signal outputted by the second low pass filter 44 with a quadrature-phase local oscillating signal (LOQₜ) so as to generate a quadrature-phase radio-frequency signal (RFQₜ). The adder 47 combines the output signals of the first and second frequency mixers 45, 46 to result in another radio-frequency signal.

The detecting unit 48 is coupled electrically to the adder 47 of the transmitting module 4 for generating a detection signal that represents an extent of in-phase/quadrature-phase (I/Q) mismatch based on the radio-frequency signal received from the adder 47. In this embodiment, the detecting unit 48 includes a mixer 481, a variable gain amplifier 482, an analog-to-digital converter 483, and a fast Fourier transformer 484 for respectively performing signal mixing of the radio-frequency signal outputted by the adder 47 with itself, followed in sequence by amplification, analog-to-digital conversion and fast Fourier transformation so as to generate the detection signal. When each of the first and second baseband signals (BBIₜ), (BBQ_{T}) is a sinusoidal signal and has a frequency of (F_{BBn}), the signal outputted by the mixer 481 has a frequency spectrum component at (2F_{BBn}), and frequency spectrum analysis of the signal outputted by the frequency mixer 481 reflects the extent of the I/Q mismatch. It should be noted herein that, in other embodiments of the present invention, the mixer 481 may be replaced by an envelope detector, and the variable gain amplifier 482 can be omitted.

The adjusting unit 49 is coupled electrically to the transmitting module 4 and the detecting unit 48, and controls values of the set of parameters (i.e., the variable delay time (τₜ) and the variable gains (Xₜ), (Yₜ)) according to the detection signal received from the detecting unit 48 so as to reduce the extent of I/Q mismatch. Further details are provided below.

It should be noted herein that, in other embodiments of the present invention, the location of the delay stage 401 with respect to other components in the transmitting module 4 may be different, such as, between the first low pass filter 43 and the first mixer 45, or between the second low pass filter 44 and the second mixer 46, as illustrated by phantom lines, and is not limited to that disclosed herein.

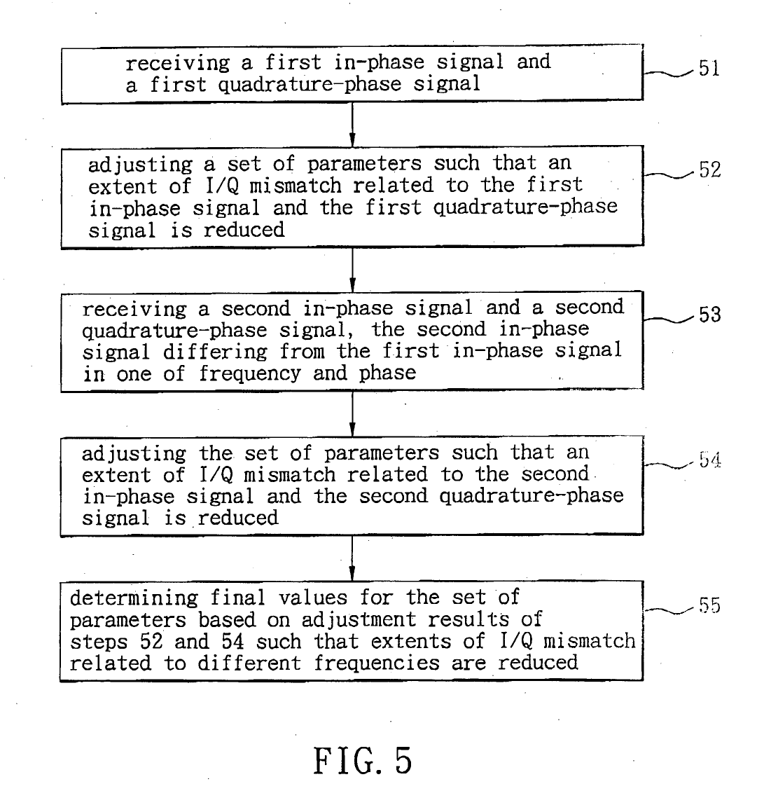

Referring to FIG. 5, the adjusting method for reducing in-phase/quadrature-phase (I/Q) mismatch carried out by the transmitter according to this embodiment includes the following steps.

In step 51, the compensating unit 40 receives a first sinusoidal in-phase signal and a first sinusoidal quadrature-phase signal, respectively serving as the first and second baseband signals (BBIₜ), (BBQₜ) in FIG. 4.

In step 52, the adjusting unit 49 adjusts the set of parameters such that the extent of I/Q mismatch related to the first in-phase signal and the first quadrature-phase signal is reduced. In this step, the extent of I/Q mismatch is reduced to one of a substantially minimum value and a predetermined threshold value.

Instep 53, the compensating unit 40 receives a second sinusoidal in-phase signal and a second sinusoidal quadrature-phase signal respectively serving as the first and second baseband signals (BBIₜ), (BBQₜ) in FIG. 4. The second in-phase signal differs from the first in-phase signal in one of frequency and phase.

In step 54, the adjusting unit 49 adjusts the set of parameters such that the extent of I/Q mismatch related to the second in-phase signal and the second quadrature-phase signal is reduced. In this step, the extent of I/Q mismatch is reduced to one of a substantially minimum value and a predetermined threshold value.

In step 55, the adjusting unit 49 determines final values for the set of parameters based on adjustment results of steps 52 and 54 such that extents of I/Q mismatch related to different frequencies are reduced. In this step, the extent of I/Q mismatch is reduced to one of a substantially minimum value and a predetermined threshold value.

In an application of this embodiment, the first in-phase signal is cos(2πF_{BB1}t), the first quadrature-phase signal is sin(2πF_{BB1}t), the second in-phase signal is cos(2πF_{BB2}t), and the second quadrature-phase signal is sin(2πF_{BB2}t). The frequency (F_{BB2}) of the second in-phase signal is different from the frequency (F_{BB1}) of the first in-phase signal. In addition, the in-phase local oscillating signal (LOIₜ) is cos(2πF_{LO}t), and the quadrature-phase local oscillating signal (LOQₜ) is −sin(2πF_{LO}t).

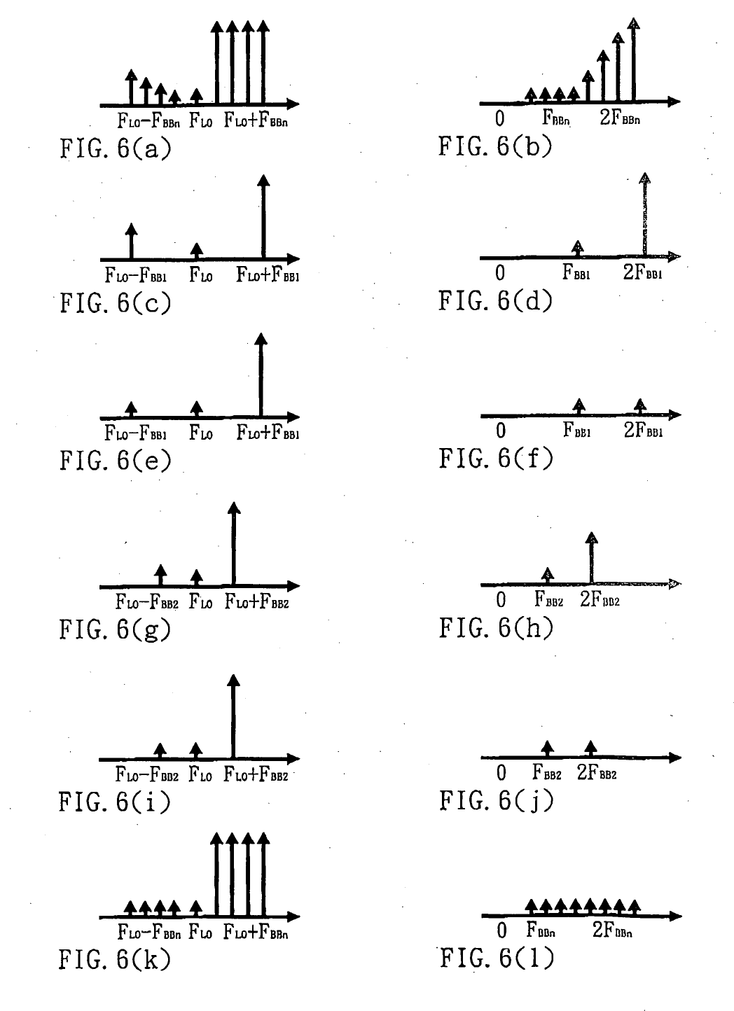

Before the transmitter performs the adjusting method, as shown in FIG. 6(a), the signals outputted by the adder 47 of the transmitting module 4 have desired frequency spectrum components at (F_{LO}+F_{BBn}), and image frequency spectrum components at (F_{LO}−F_{BBn}). Even if power of the desired frequency spectrum components does not vary with frequency, power of the image frequency spectrum components varies with frequency. As shown in FIG. 6(b), the signals outputted by the mixer 481 have frequency spectrum components at (2F_{BBn}), whose power varies with frequency.

After step 51 is executed by the transmitter of the present invention, as shown in FIG. 6(c), the signal outputted by the adder 47 has a desired frequency spectrum component at (F_{LO}+F_{BB1}), and an image frequency spectrum component at (F_{LO}−F_{BB1}). As shown in FIG. 6(d), the signal outputted by the mixer 481 has a frequency spectrum component at (2F_{BB1}), and frequency spectrum analysis of the signal outputted by the mixer 481 will reflect the extent of I/Q mismatch related to the first in-phase signal and the first quadrature-phase signal.

After step 52 is executed by the transmitter of the present invention, as shown in FIG. 6(e), the signal outputted by the adder 47 has a desired frequency spectrum component at (F_{LO}+F_{BB1}), and an image frequency spectrum component at (F_{LO}−F_{BB1}), where the power of the image frequency spectrum component is reduced as compared to that shown in FIG. 6(c). Furthermore, as shown in FIG. 6(f), the signal outputted by the mixer 401 has a frequency spectrum component at (2F_{BB1}), the power of which is reduced as compared to that shown in FIG. 6(d). Consequently, the extent of I/Q mismatch related to the first in-phase signal and the first quadrature-phase signal is also reduced as compared to the case shown in FIG. 6(d).

After step 53 is executed by the transmitter of the present invention, as shown in FIG. 6(g), the signal outputted by the adder 47 has a desired frequency spectrum component at (F_{LO}+F_{BB2}), and an image frequency spectrum component at (F_{LO}−F_{BB2}). As shown in FIG. 6(h), the signal outputted by the mixer 481 has a frequency spectrum component at (2F_{BB2}), and frequency spectrum analysis of the signal outputted by the mixer 481 will reflect the extent of I/Q mismatch related to the second in-phase signal and the second quadrature-phase signal.

After step 54 is executed by the transmitter of the present invention, as shown in FIG. 6(i), the signal outputted by the adder 47 has a desired frequency spectrum component at (F_{LO}+F_{BB2}), and an image frequency spectrum component at (F_{LO}−F_{BB2}), where the power of the image frequency spectrum component is reduced as compared to that shown in FIG. 6(g). Furthermore, as shown in FIG. 6(j), the signal outputted by the mixer 481 has a frequency spectrum component at (2F_{BB2}), the power of which is reduced as compared to that shown in FIG. 6(h). Consequently, the extent of I/Q mismatch related to the second in-phase signal and the second quadrature-phase signal is also reduced as compared to the case shown in FIG. 6(h).

After step 55 is executed by the transmitter of the present invention, as shown in FIG. 6(k), the signals outputted by the adder 47 have desired frequency spectrum components at (F_{LO}+F_{BBn}), and image frequency spectrum components at (F_{LO}−F_{BBn}), where the powers of the image frequency spectrum components of different frequencies are all minimized. As for the prior art, the power is only reduced for an image frequency spectrum component at a certain frequency.

Moreover, as shown in FIG. 6(l), the signals outputted by the mixer 481 have frequency spectrum components at (2F_{BBn}), and the powers of these frequency spectrum components at different frequencies are all minimized. As for the prior art, the power is only reduced for the frequency spectrum component at a certain frequency. In other words, the extents of I/Q mismatch related to different frequencies are all reduced in the present invention.

In another application of this embodiment, the first in-phase signal is cos(2πF_{BB1}t), the first quadrature-phase signal is sin(2πF_{BB1}t), the second in-phase signal is sin(2πF_{BB1}t), and the second quadrature-phase signal is cos(2πF_{BB1}t). The second in-phase signal differs from the first in-phase signal in phase. The in-phase local oscillating signal (LOIₜ) is cos(2πF_{LO}t), and the quadrature-phase local oscillating signal (LOQₜ) is −sin(2πf_{LO}t).

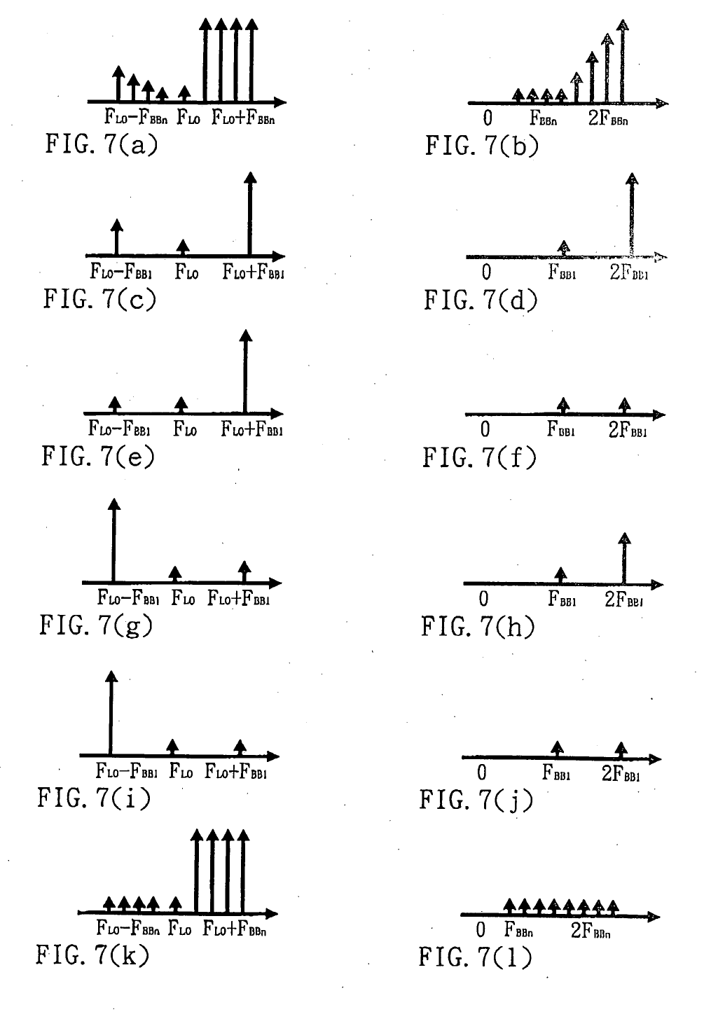

Before the transmitter performs the adjusting method, as shown in FIG. 7(a), the signals outputted by the adder 47 have desired frequency spectrum components at (F_{LO}+F_{BBn}), and image frequency spectrum components at (F_{LO}−F_{BBn}). Even if power of the desired frequency spectrum components does not vary with frequency, power of the image frequency spectrum components varies with frequency. As shown in FIG. 7(b), the signals outputted by the mixer 481 have frequency spectrum components at (2F_{BBn}), whose power varies with frequency.

After step 51 is executed by the transmitter of the present invention, as shown in FIG. 7(c), the signal outputted by the adder 47 has a desired frequency spectrum component at (F_{LO}+F_{BB1}), and an image frequency spectrum component at (F_{LO}−F_{BB1}). As shown in FIG. 7(d), the signal outputted by the mixer 481 has a frequency spectrum component at (2F_{BB1}), and frequency spectrum analysis of the signal outputted by the mixer 481 will reflect the extent of I/Q mismatch related to the first in-phase signal and the first quadrature-phase signal.

After step 52 is executed by the transmitter of the present invention, as shown in FIG. 7(e), the signal outputted by the adder 47 has a desired frequency spectrum component at (F_{LO}+F_{BB1}), and an image frequency spectrum component at (F_{LO}−F_{BB1}), where the power of the image frequency spectrum component is reduced as compared to that shown in FIG. 7(c). Furthermore, as shown in FIG. 7(f), the signal outputted by the mixer 481 has a frequency spectrum component at (2F_{BB1}), the power of which is reduced as compared to that shown in FIG. 7(d). Consequently, the extent of I/Q mismatch related to the first in-phase signal and the first quadrature-phase signal is also reduced as compared to the case shown in FIG. 7(d).

After step 53 is executed by the transmitter of the present invention, as shown in FIG. 7(g), the signal outputted by the adder 47 has a desired frequency spectrum component at (F_{LO}−F_{BB1}), and an image frequency spectrum component at (F_{LO}+F_{BB1}) As shown in FIG. 7(h), the signal outputted by the frequency mixer 481 has a frequency spectrum component at (2F_{BB1}), and frequency spectrum analysis of the signal outputted by the mixer 481 will reflect the extent of I/Q mismatch related to the second in-phase signal and the second quadrature-phase signal.

After step 54 is executed by the transmitter of the present invention, as shown in FIG. 7(i), the signal outputted by the adder 47 has a desired frequency spectrum component at (F_{LO}−F_{BB1}), and an image frequency spectrum component at (F_{LO}+F_{BB1}), where the power of the image frequency spectrum component is reduced as compared to that shown in FIG. 7(g). Furthermore, as shown in FIG. 7(j), the signal outputted by the mixer 481 has a frequency spectrum component at (2F_{BB1}), the power of which is reduced as compared to that shown in FIG. 7(h). Consequently, the extent of I/Q mismatch related to the second in-phase signal and the second quadrature-phase signal is also reduced as compared to the case shown in FIG. 7(h).

After step 55 is executed by the transmitter of the present invention, as shown in FIG. 7(k), the signals outputted by the adder 47 have desired frequency spectrum components at (F_{LO}+F_{BBn}), and image frequency spectrum components at (F_{LO}−F_{BBn}), where the powers of the image frequency spectrum components of different frequencies are all minimized. As for the prior art, the power is only reduced for an image frequency spectrum component at a certain frequency.

Moreover, as shown in FIG. 7(l), the signals outputted by the mixer 481 have frequency spectrum components at (2F_{BBn}), and the powers of these frequency spectrum components at different frequencies are all minimized. As for the prior art, the power is only reduced for the frequency spectrum component at a certain frequency. In other words, the extents of I/Q mismatch related to different frequencies are all reduced in the present invention.

It is worth to note that, in this embodiment, the second in-phase signal and the second quadrature-phase signal may be generated according to the first in-phase signal and the first quadrature-phase signal. For example, in step 53, by using a switching unit, the first in-phase signal may be fed into the input end for the baseband signal (BBQₜ) to serve as the second quadrature-phase signal, and the first quadrature-phase signal may be fed into the input end for the baseband signal (BBIₜ) to serve as the second in-phase signal. Alternatively, for example, in step 53, by using a delay unit, the first in-phase signal can be delayed by a period of time so as to generate the second quadrature-phase signal, and the first quadrature-phase signal may be delayed by a period of time so as to generate the second in-phase signal. In other words, the disclosure herein should not be construed as a limitation to the present invention.

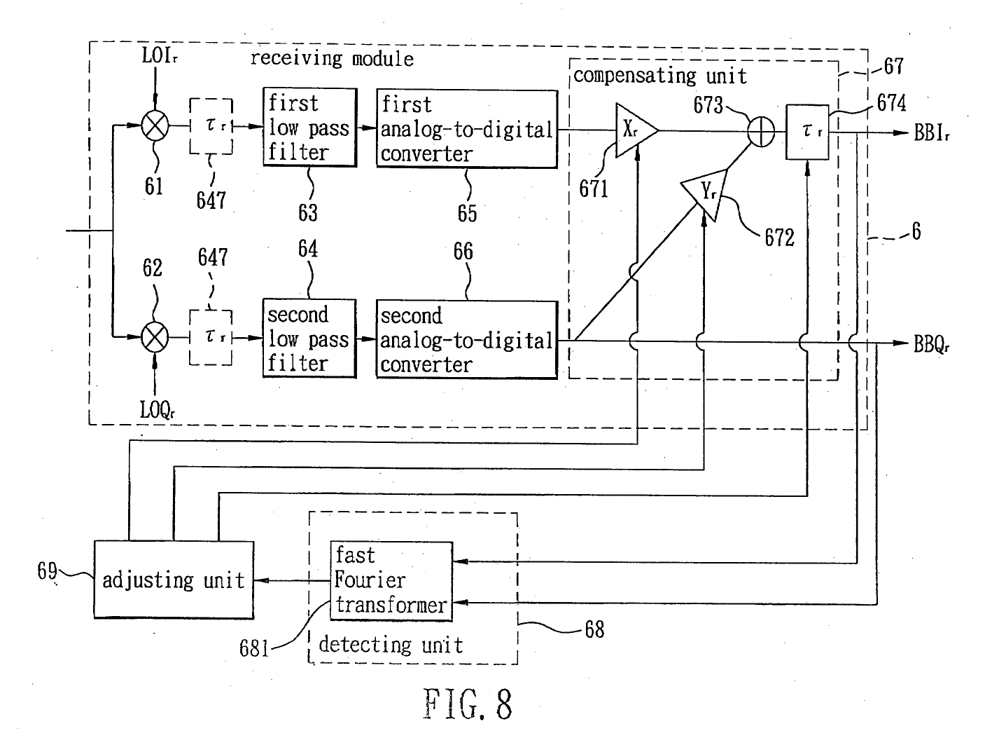

Referring to FIG. 8, a receiver according to the preferred embodiment of the present invention is shown to include a receiving module 6, a detecting unit 68, and an adjusting unit 69. The receiving module 6 includes first and second mixers 61, 62, first and second low pass filters 63, 64, first and second analog-to-digital converters 65, 66, and a compensating unit 67, and performs in-phase signal and quadrature-phase signal signal mixing, as well as phase and amplitude compensation according to a set of parameters, on a radio-frequency signal received thereby so as to generate a pair of baseband in-phase and quadrature-phase signals.

In particular, the first mixer 61 performs signal mixing on the radio-frequency signal and an in-phase local oscillating signal (LOIₜ) so as to generate a baseband signal, and the second frequency mixer 62 performs signal mixing on the radio-frequency signal and a quadrature-phase local oscillating signal (LOQᵣ) so as to generate another baseband signal. The first and second low pass filters 63, 64 respectively perform low pass filtering on signals outputted by the first and second mixers 61, 62. The first and second analog-to-digital converters 65, 66 respectively perform analog-to-digital conversion on the signals outputted by the first and second low pass filters 63, 64.

The compensating unit 67 performs phase and amplitude compensation on signals outputted by the first and second analog-to-digital converters 65, 66 according to the set of parameters. In this embodiment, the set of parameters include a pair of variable gains (Xᵣ), (Yᵣ) and a variable delay time (τᵣ). The variable delay time (τᵣ) is for use in frequency-dependent phase compensation, and the variable gains (Xᵣ), (Yᵣ) are for use in fixed amplitude compensation and fixed phase compensation. The compensating unit 67 includes first and second gain stages 671, 672, an adder 673, and a delay stage 674. The first gain stage 671 multiplies the signal outputted by the first analog-to-digital converter 65 by the variable gain (Xᵣ). The second gain stage 672 multiplies the signal outputted by the second analog-to-digital converter by the variable gain (Yᵣ) The adder 673 combines signals outputted by the first and second gain stages 671, 672. The delay stage 674 delays a signal outputted by the adder 673 by the variable delay time (τᵣ) so as to generate the baseband in-phase signal (BBIᵣ). The compensating unit 67 further outputs the signal from the second analog-to-digital converter 66 directly as the baseband quadrature-phase signal (BBQᵣ).

The detecting unit 68 is coupled electrically to the compensating unit 67 of the receiving module 6 for generating a detection signal that represents an extent of in-phase/quadrature-phase (I/Q) mismatch based on the baseband in-phase and quadrature-phase signals (BBIᵣ), (BBQᵣ) received from the receiving module 6. In this embodiment, the detecting unit 68 includes a fast Fourier transformer 681. The fast Fourier transformer 681 takes the baseband in-phase and quadrature-phase signals (BBIᵣ), (BBQᵣ) as a complex signal (BBIᵣ+jBBQᵣ) in order to perform fast Fourier transformation so as to generate the detection signal. When the radio-frequency signal is a signal without I/Q mismatch, e.g., when the radio-frequency signal is generated by the transmitter of the present invention after completing the adjusting method, and when the baseband in-phase and quadrature-phase signals (BBIᵣ), (BBQᵣ) are sinusoidal signals and have a frequency of (F_{BBn}), the baseband in-phase and quadrature-phase signals (BBIᵣ), (BBQᵣ) would have frequency spectrum components at (−F_{BBn}), and frequency spectrum analysis of the signal outputted by the frequency mixer 481 will reflect the extent of I/Q mismatch.

The adjusting unit 69 is coupled electrically to the receiving module 6 and the detecting unit 68, and controls values of the set of parameters (i.e., the variable gains (Xᵣ), (Yᵣ) and the variable delay time (τᵣ)) according to the detection signal received from the detecting unit 68 so as to reduce the extent of I/Q mismatch.

It should be noted herein that, in other embodiments of the present invention, the location of the delay stage 674 with respect to other components in the receiving module 6 may be different, such as, between the first low pass filter 63 and the first mixer 61, or between the second low pass filter 64 and the second mixer 62, as illustrated by phantom lines, and is not limited to that disclosed herein.

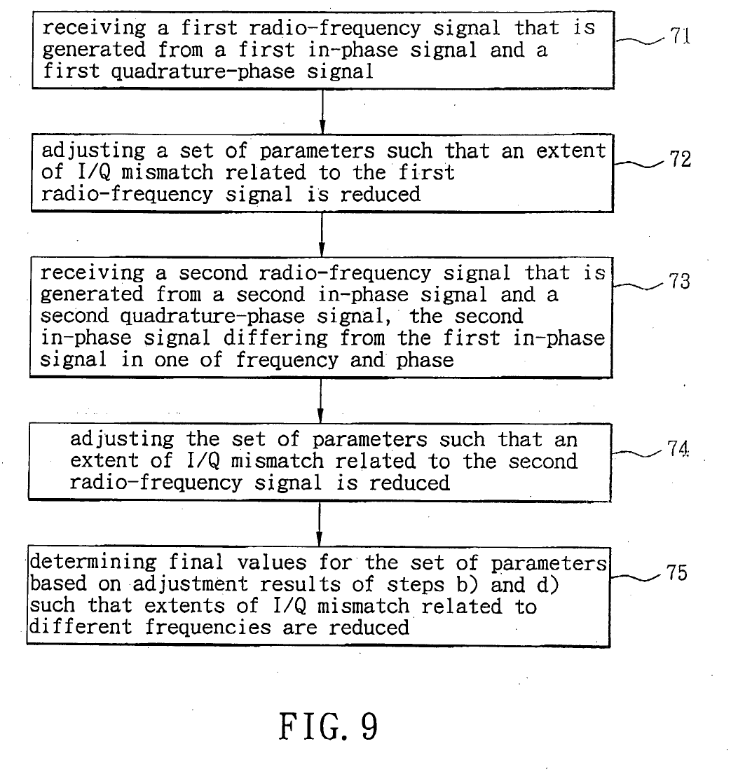

Referring to FIG. 9, the adjusting method for reducing in-phase/quadrature-phase (I/Q) mismatch carried out by the receiver according to this embodiment includes the following steps.

In step 71, the first and second mixers 61, 62 receive a first radio-frequency signal generated from a first in-phase signal and a first quadrature-phase signal that are both sinusoidal signals.

In step 72, the adjusting unit 69 adjusts the set of parameters such that an extent of I/Q mismatch related to the first radio-frequency signal is reduced according to the detection signal generated by the detecting unit 68. In this step, the extent of I/Q mismatch is reduced to one of a substantially minimum value and a predetermined threshold value.

In step 73, the first and second mixers 61, 62 receive is a second radio-frequency signal generated from a second in-phase signal and a second quadrature-phase signal, where the second in-phase signal differs from the first in-phase signal in one of frequency and phase.

In step 74, the adjusting unit 69 adjusts the set of parameters such that an extent of I/Q mismatch related to the second radio-frequency signal is reduced according to the detection signal generated by the detecting unit 68. In this step, the extent of I/Q mismatch is reduced to one of a substantially minimum value and a predetermined threshold value.

In step 75, the adjusting unit 69 determines final values for the set of parameters based on adjustment results of steps 72 and 74 such that extents of I/Q mismatch related to different frequencies are reduced. In this step, the extent of I/Q mismatch is reduced to one of a substantially minimum value and a predetermined threshold value.

In an application of this embodiment, the first in-phase signal is cos(2πF_{BB1}t), the first quadrature-phase signal is sin(2πF_{BB1}t), the second in-phase signal is cos(2πF_{BB2}t), and the second quadrature-phase signal is sin(2πF_{BB2}t). The frequency (F_{BB2}) of the second in-phase signal is different from the frequency (F_{BB1}) of the first in-phase signal. In addition, the in-phase local oscillating signal (LOIᵣ) is cos(2πF_{LO}t), and the quadrature-phase local oscillating signal (LOQᵣ) is −sin(2πF_{LO}t).

In another application of this embodiment, the first in-phase signal is cos(2πF_{BB1}t), the first quadrature-phase signal is sin(2πF_{BB1}t), the second in-phase signal is sin(2πF_{BB1}t), and the second quadrature-phase signal is cos(2πF_{BB1}t). The second in-phase signal differs from the first in-phase signal in phase. The in-phase local oscillating signal (LOIᵣ) is cos(2πF_{LO}t), and the quadrature-phase local oscillating signal (LOQᵣ) is −sin(2πF_{LO}t).

For both application of the receiver of the present invention, the effect of reducing the extents of I/Q mismatch related to different frequencies is achieved.

It should be noted herein that, in other embodiments of the transmitter and the receiver, the adjustment of the sets of parameters can be performed more than twice (i.e., steps 52, 54 (72, 74) can be repeated using other signals) prior to the determination of the final values, and should not be limited to what is disclosed herein.

While the present invention has been described in connection with what is considered the most practical and preferred embodiment, it is understood that this invention is not limited to the disclosed embodiment 1s but is intended to cover various arrangements included within the spirit and scope of the broadest interpretation so as to encompass all such modifications and equivalent arrangements.

What is claimed is:

1. An adjusting method for reducing in-phase/quadrature-phase (I/Q) mismatch in a transmitter, the adjusting method comprising the steps of:
a) receiving a first in-phase signal and a first quadrature-phase signal;
b) adjusting a set of parameters such that an extent of I/Q mismatch related to the first in-phase signal and the first quadrature-phase signal is reduced;
c) receiving a second in-phase signal and a quadrature-phase signal, the second in-phase signal differing from the first in-phase signal in one of frequency and phase;
d) adjusting the set of parameters such that an extent of I/Q mismatch related to the second in-phase signal and the second quadrature-phase signal is reduced; and
e) determining final values for the set of parameters based on adjustment results of steps b) and d) such that extents of I/Q mismatch related to different frequencies are reduced.

2. The adjusting method as claimed in claim 1, wherein the set of parameters include a variable delay time for use in frequency-dependent phase compensation.

3. The adjusting method as claimed in claim 2, wherein the set of parameters further include a pair of variable gains for use in fixed amplitude compensation and fixed phase compensation.

4. The adjusting method as claimed in claim 1, wherein the second in-phase signal differs from the first in-phase signal in frequency.

5. The adjusting method as claimed in claim 1, wherein the second in-phase signal differs from the first in-phase signal in phase.

6. The adjusting method as claimed in claim 1, wherein in steps b), d) and e), the extent of I/Q mismatch is reduced to one of a substantially minimum value and a predetermined threshold value.

7. The adjusting method as claimed in claim 6, wherein in step e), the extents of I/Q mismatch related to different frequencies are reduced to the substantially minimum value.

8. The adjusting method as claimed in claim 1, wherein each of the first in-phase signal, the first quadrature-phase signal, the second in-phase signal and the second quadrature-phase signal is a sinusoidal signal.

9. An adjusting method for reducing in-phase/quadrature-phase (I/Q) mismatch in a receiver, the adjusting method comprising the steps of:
a) receiving a first radio-frequency signal that is generated from a first in-phase signal and a first quadrature-phase signal;
b) adjusting a set of parameters such that an extent of I/Q mismatch related to the first radio-frequency signal is reduced;
c) receiving a second radio-frequency signal that is generated from a second in-phase signal and a second quadrature-phase signal, the second in-phase signal differing from the first in-phase signal in one of frequency and phase;
d) adjusting the set of parameters such that an extent of I/Q mismatch related to the second radio-frequency signal is reduced; and
e) determining final values for the set of parameters based on adjustment results of steps b) and d) such that extents of I/Q mismatch related to different frequencies are reduced.

10. The adjusting method as claimed in claim 9, wherein the set of parameters include a variable delay time for use in frequency-dependent phase compensation.

11. The adjusting method as claimed in claim 10, wherein the set of parameters further include a pair of variable gains for use in fixed amplitude compensation and fixed phase compensation.

12. The adjusting method as claimed in claim 9, wherein the second in-phase signal differs from the first in-phase signal in frequency.

13. The adjusting method as claimed in claim 9, wherein the second in-phase signal differs from the first in-phase signal in phase.

14. The adjusting method as claimed in claim 9, wherein in steps b), d) and e), the extent of I/Q mismatch is reduced to one of a substantially minimum value and a predetermined threshold value.

15. The adjusting method as claimed in claim 14, wherein in step e), the extents of I/Q mismatch related to different frequencies are reduced to the substantially minimum value.

16. The adjusting method as claimed in claim 9, wherein each of the first in-phase signal, the first quadrature-phase signal, the second in-phase signal and the second quadrature-phase signal is a sinusoidal signal.

17. A transmitter comprising:
a transmitting module performing phase and amplitude compensation according to a set of parameters, as well as signal mixing on an in-phase signal and a quadrature-phase signal, followed by combining to result in a radio-frequency signal;
a detecting unit coupled electrically to the transmitting module and generating a detection signal that represents an extent of in-phase/quadrature-phase (I/Q) mismatch based on the radio-frequency signal received from the transmitting module; and
an adjusting unit coupled electrically to the transmitting module and the detecting unit, and controlling values of the set of parameters according to the detection signal received from the detecting unit so as to reduce the extent of I/Q mismatch;
wherein the adjusting unit adjusts the values of the set of parameters when the detection signal is generated for a first set of in-phase and quadrature-phase signals such that the extent of I/Q mismatch related to the first set of in-phase and quadrature-phase signals is reduced, adjusts the values of the set of parameters when the detection signal is generated for a second set of in-phase and quadrature-phase signals such that the extent of I/Q mismatch related to the second set of in-phase and quadrature-phase signals is reduced, and determines final values of the set of parameters based on the adjustment results such that the extents of I/Q mismatch related to different frequencies are reduced;
the second in-phase signal differing from the first in-phase signal in one of frequency and phase.

18. The transmitter as claimed in claim 17, wherein the set of parameters include a variable delay time for use in frequency-dependent phase compensation.

19. The transmitter as claimed in claim 18, wherein the set of parameters further include a pair of variable gains for use in fixed amplitude compensation and fixed phase compensation.

20. A receiver comprising:
a receiving module for performing in-phase signal and quadrature-phase signal mixing, as well as phase and amplitude compensation according to a set of parameters, on a radio-frequency signal received thereby so as to generate a pair of baseband in-phase and quadrature-phase signals;
a detecting unit coupled electrically to the receiving module for generating a detection signal that represents an extent of in-phase/quadrature-phase (I/Q) mismatch based on the baseband in-phase and quadrature-phase signals received from the receiving module; and
an adjusting unit coupled electrically to the receiving module and the detecting unit, and controlling values of the set of parameters according to the detection signal received from the detecting unit so as to reduce the extent of I/Q mismatch;
wherein the adjusting unit adjusts the values of the set of parameters when the detection signal is generated for a first radio frequency signal such that the extent of I/Q mismatch related to the first radio frequency signal is reduced, adjusts the values of the set of parameters when the detection signal is generated for a second radio frequency signal such that the extent of I/Q mismatch related to the second radio frequency signal is reduced, and determines final values of the set of parameters based on the adjustment results such that the extents of I/Q mismatch related to different frequencies are reduced;
the receiving module generating a pair of first baseband in-phase and quadrature-phase signals from the first radio frequency signal, and generating a pair of second baseband in-phase and quadrature-phase signals from the second radio frequency signal, the second baseband in-phase signal differing from the first baseband in-phase signal in one of frequency and phase.

21. The receiver as claimed in claim 20, wherein the set of parameters include a variable delay time for use in frequency-dependent phase compensation.

22. The receiver as claimed in claim 21, wherein the set of parameters further include a pair of variable gains for use in fixed amplitude compensation and fixed phase compensation.
